(19) United States
(12) Patent Application Publication
(10) Pub. No.: US 2004/0065813 A1
(43) Pub. Date: Apr. 8, 2004

(54) Safe path night light

(76) Inventor: Daniel F. Goldstein, West Palm Beach, FL (US)

Correspondence Address: ROBERT M. SKOLNIK, 353 MONMOUTH ROAD, PO BOX 22, WEST LONG BRANCH, NJ, 07764-0022, US

(21) Appl. No.: 10/679,639

(22) Filed: Oct. 6, 2003

Related U.S. Application Data
(60) Provisional application No. 60/416,947, filed on Oct. 8, 2002.

(51) Int. Cl. G06M 7/00; H01J 40/14

(52) U.S. Cl. 250/221

(57) ABSTRACT

A sensor causes a string of lights, for example, those sold under the trademark LIGHT ROPE® for assisting persons to walk in a darkened room to avoid accidents. The system incorporates a motion detector (with or without time delay to keep lights ON) and a string of lights, for example, those sold under the trademark LIGHT ROPE®. The lights are laid out along a path in the home.

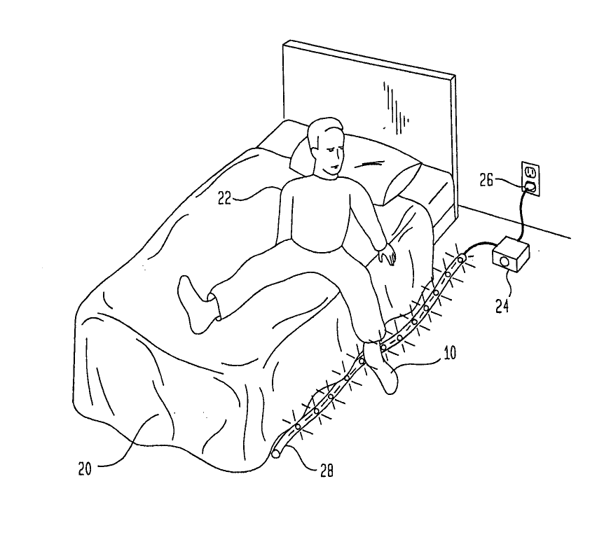

### CROSS REFERENCE TO RELATED APPLICATIONS

This application claims priority based on U.S. Provisional Application Serial No. 60/416,947, filed Oct. 8, 2002.

### BACKGROUND OF THE INVENTION

1. Field of the Invention

The present invention is a system for assisting persons to walk in a darkened room to avoid accidents. The system incorporates a motion detector (with or without time delay to keep lights ON) and a string of lights, for example, those sold under the mark LIGHT ROPE®. The lights are laid out along a path in the home.

2. Description of the Related Art

The prior art discloses various structures for illuminating a person's pathway.

Woodman, U.S. Pat. No. 934,122 discloses wooden steps with lights actuated by a person stepping on each landing.

Donahue, U.S. Pat. No. 4,425,601 is similar to Woodman in using pressure sensitive switches on stairs to illuminate lights on each landing.

Kirk, U.S. Pat. No. 4,544,993, shows an illuminating mat to be placed on the floor. The lights go ON by pressure sensitive switches.

Johnson, U.S. Pat. No. 5,019,950, is similar in concept but different in structure from the invention. Johnson actuates a timed night-light from a pressure sensitive switch mat.

Ness, U.S. Pat. No. 5,763,872, shows motion detectors incorporated in individual path lights.

Nishihira et al, U.S. Pat. No. 6,166,640 disclose an electronic lighting control in a room occupancy sensor system.

Shaefer, U.S. Pat. No. 6,390,647 teaches an indoor/outdoor night light which can be turned on by motion detection, ambient light detection or manually.

### SUMMARY OF THE INVENTION

The present invention assists persons to walk in darkened rooms thereby avoiding accidents. A motion detector which may incorporate a delay to maintain illumination for a predetermined time is connected to a string of small lights preferably having bulbs set into a plastic strip such as sold under the trademark LIGHT ROPE®. The motion detector turns on the lights to illuminate a path after sensing motion of a person. This eliminates the need to illuminate the entire room and also eliminates the need for any action by the user to activate the illumination.

By way of example, a strip of lights may be fastened along the baseboard of a room to provide lighting for a person to safely navigate from bed to bath A principal object and advantage of this invention is the provision of a night light system, which illuminates a predetermined path.

Another object and advantage of this invention is the provision of a night light system, which may be activated by a motion detector.

A still further object and advantage of the invention is the provision of a night light system, which is illuminated for a predetermined time.

Another object and advantage of this invention is the provision of a night light system, which provides illumination without the need for any actions by a person other than moving within the range of a motion detector.

The foregoing, as well as further objects and advantages of the invention will become apparent to those skilled in the art from a review of the following detailed description of my invention, reference being made to the accompanying drawings.

### BRIEF DESCRIPTION OF THE DRAWINGS

THE FIGURE is a perspective view of the system of this invention.

### DETAILED DESCRIPTION OF THE PREFERRED EMBODIMENT

THE FIGURE is a perspective view of the system of this invention. A person 22 is shown leaving bed 20. A motion detector 24 detects that motion. The detector 24 serves to turn ON and OFF a LIGHT ROPE® 28. The motion detector 24 is directly plugged in to wall plug 26. The LIGHT ROPE® 28 may be located along a wall or on the floor to illuminate and create a path.

It will be understood that an additional motion detector may be used to activate the lights. This additional motion detector may be attached to the other end of the light string so that both ends of the string can illuminate it. Further, the components used may be those suitable for use indoors or outdoors. Similarly, light strings other than the LIGHT ROPE® may be employed and may be actuated by remote sensors.

Further modifications to the apparatus of the invention may be made without departing from the spirit and scope of the invention; accordingly, what is sought to be protected is set forth in the appended claims.

I claim:

1. A system for illuminating an area on the occurrence of a predetermined event comprising: a series of lights which are normally OFF; sensor means connected to said series of lights for activating them on the occurrence of a predetermined event; and means connected to said series of lights and said sensor means for providing electrical energy thereto.

2. The system of claim 1 wherein said predetermined event is motion in proximity to said sensor means.

3. An illuminating system comprising: a series of lights mounted in an area to be illuminated; motion sensor means connected to said series of lights for illuminating said series of lights on the occurrence of motion in proximity to said sensor means; and electrical power means connected to said series of lights and said motion sensor means for providing electrical energy thereto.

4. A path lighting system comprising: a plurality of lights connected together to be located adjacent a path to be illuminated; sensor means connected to said lights for turning them ON upon the occurrence of a predetermined event; and means connected to said lights and said sensor means for providing electrical power thereto.
